(19) United States
(12) Patent Application Publication
(10) Pub. No.: US 2006/0146688 A1
(43) Pub. Date: Jul. 6, 2006

(54) Capacitor microphone

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/302,110

(22) Filed: Dec. 14, 2005

(30) Foreign Application Priority Data
Jan. 5, 2005 (JP) 2005-001009

(51) Int. Cl. H04L 5/20

(52) U.S. Cl. 370/200

(57) ABSTRACT

In a capacitor microphone, a microphone circuit is selectively operated by a phantom power supply receiving power from an external source and a built-in power supply. The capacitor microphone includes: a phantom power supply circuit provided between the phantom power supply and the microphone circuit; a built-in power supply circuit provided between the built-in power supply and the microphone circuit; a detector provided in the phantom power supply circuit, and detecting the presence or absence of power supplied from the phantom power supply; and a switch provided in the built-in power supply circuit and interrupting the built-in power supply circuit when the detector detects the presence of power supplied from the phantom power supply.

### CROSS REFERENCE TO RELATED APPLICATION

This application is based upon and claims the benefit of priority from the prior Japanese Patent Application No. 2005-1009 filed on or around Jan. 5, 2005, the entire contents of which are incorporated herein as reference.

### BACKGROUND OF THE INVENTION

1. Field of the Invention

This invention relates to a capacitor microphone, and more particularly relates to a circuit which selectively activates a phantom power supply circuit and a built-in power supply circuit.

2. Description of the Related Art

Usually, a capacitor microphone includes an impedance transducer which is constituted by a field effect transistor (FET). This is because a capacitor microphone unit as an electro-acoustic transducer has high impedance. A power supply has to be provided in order to operate the impedance transducer. The capacitor microphone generally includes a built in power supply, i.e., a battery, and a mixer or a phantom power supply which receives power from an external source. The phantom power supply feeds power to a microphone via an output cord as specified by Standard RC-8162A “Power Supply Method for Microphone” of Electronic and Mechanical Engineering Association of Japan (EIAJ). Refer to Japanese Patent Laid-Open Publication No. 2002-369,275.

Usually, a relatively inexpensive and general purpose capacitor microphone is operated only by a built-in battery. On the other hand, if operated only by such a built-in battery, a professional-use capacitor microphone cannot remain operative after the battery is used up, which is not preferable. In order to overcome such a problem, a phantom power supply is usually used as a main power supply while the built-in power supply is used as an auxiliary power supply whenever the phantom power supply becomes unusable.

It is assumed here that a capacitor microphone is provided with a phantom power supply together with a built-in battery. If power is simultaneously supplied both by the phantom power supply and the built-in battery, currents will flow into the built-in battery, which would result in problems such as heating of and liquid spill from the builtin battery. In order to overcome the problems, a diode is connected in series between the battery and the phantom power supply in such a capacitor microphone.

FIG. 2 of the accompanying drawings shows an example of an existing capacitor microphone including a diode. A capacitor microphone unit 10 has its one terminal earthed and the other end thereof connected to a microphone circuit 12. The microphone circuit 12 includes an FET transducing the impedance of the microphone unit 10 to low impedance, an amplifier and so on. In the microphone circuit 12, a grounding terminal is earthed, and a power supply terminal receives power not only from a phantom power supply circuit 14 but also from a builtin battery 20. A constant current circuit 16 constituted by a constant current diode is connected to the phantom power supply circuit 14, so that a constant current is supplied to the microphone circuit 12 while the phantom power supply is in use, which is effective in controlling consumption currents. For instance, a backflow preventing diode 22 such as a schottky diode is connected to a power supply circuit for the built-in battery 20, thereby preventing currents from flowing to the built-in battery 20 from the phantom power supply. A negative terminal of the built-in battery 20 is grounded.

An output terminal of the microphone circuit 12 is connected to one of terminals of a primary coil 26 of a transformer 24. The other terminal of the primary coil 26 is grounded. A microphone body includes a standardized three-pin connector, to which a cable connector is attached. Therefore, phantom power is supplied to the microphone circuit 12 from an external source, and a electro-acoustically transduced microphone output is sent to an external circuit. A grounding wire is connected to a grounding terminal of a cable, and is then connected to a grounding terminal of the external circuit. In FIG. 2, numerals 1, 2 and 3 denote terminal numbers of the connector. Specifically, No. 1 terminal is a grounding terminal; and No. 2 and No. 3 terminals are a hot-side terminal and a cold-side terminal, respectively, and produce voice signals. No. 2 terminal is connected to one of terminals of a secondary coil 28 of the transformer 24. No. 3 terminal is connected to the other terminal of the secondary coil 28. Phantom power is supplied to the microphone circuit 12 via the foregoing cable and 3-pin connector from the external source. In the microphone, a center tap is connected to the phantom power supply circuit 14, so that the phantom power is supplied to the microphone circuit 12.

In the foregoing capacitor microphone, the diode 22 prevents currents from flowing the phantom power supply to the build-in battery 20 while the phantom power is being supplied. Thus, the build-in battery 20 is protected. However, it is well-known that a certain voltage is applied across terminals even when a current flows forward in the diode 22. Therefore, a voltage supplied by the build-in battery 20 is lowered by an amount of the voltage at the terminals of the diode 22 connected between the build-in battery 20 and the power supply circuit. A reduced voltage is supplied to the microphone circuit 12. The lower the voltage to the microphone circuit 12, the lower the maximum output of the microphone. In other to overcome this problem, the diode is required to have a low forward voltage as possible. A schottky diode is preferable in such a case. However, a forward voltage of the schottky diode is 0.4V.

It is assumed here that a voltage of the build-in battery 20 is 1.5V. A power supply voltage applied to the microphone circuit 12 via the schottky diode is lowered to 1.1V or lower. In other words, the voltage of 1.5V is lowered by approximately 27%. This means that a maximum output level may be lowered by approximately 2.7 db.

### SUMMARY OF THE INVENTION

The present invention has been contemplated in order to overcome the problems of the related art, and is intended to provide a capacitor microphone in which a phantom power supply and a build-in power supply are selectively used; a voltage drop of the build-in power supply is moderate while a microphone circuit is operated by the build-in power supply; the microphone circuit always receives power whose voltage is constantly nearly equal to the voltage of the build-in power supply; and an output level of the microphone can be kept substantially constant.

Further, the invention is aimed at providing a capacitor microphone in which power from the build-in power supply is automatically interrupted while power is being supplied by the phantom power supply, and phantom power is prevented from flowing to the build-in power supply.

In a capacitor microphone, a microphone circuit is selectively operated by a phantom power supply receiving power from an external source and a built-in power supply. The capacitor microphone includes: a phantom power supply circuit provided between the phantom power supply and the microphone circuit; a built-in power supply circuit provided between the built-in power supply and the microphone circuit; a detector provided in the phantom power supply circuit, and detecting the presence or absence of power supplied from the phantom power supply; and a switch provided in the built-in power supply and interrupting the built-in power supply circuit when the detector detects the presence of power supplied from the phantom power supply.

The detector is preferably a light emitting diode provided in a photo-MOS relay, and the switch is a MOSFET provided in the photo-MOS relay and opens and closes the built-in power supply circuit in response to blinking of the light-emitting diode.

The light-emitting diode emits a light in response to power supply from the phantom power supply circuit, and the MOSFET interrupts the built-in power supply circuit in response to the light emitted by the light-emitting diode.

The detector detects power supply from the phantom power supply, and the switch interrupts the built—in power supply circuit, thereby preventing currents from flowing to the built-in power supply from the phantom power supply, and protecting the built-in power supply. On the contrary, whenever the detector detects suspension of the phantom power supply, the switch enables the built-in power supply circuit to supply power to the microphone circuit. The switch should cause no or little voltage drop.

The detector and the switch are the photo-MOS relays, and enables the built-in power supply to supply the power which is substantially free from voltage drop.

### BRIEF DESCRIPTION OF THE DRAWINGS

FIG. 1 is a circuit diagram of a capacitor microphone according to the invention; and

FIG. 2 is a circuit diagram of a capacitor microphone of the related art.

### DETAILED DESCRIPTION OF THE INVENTION

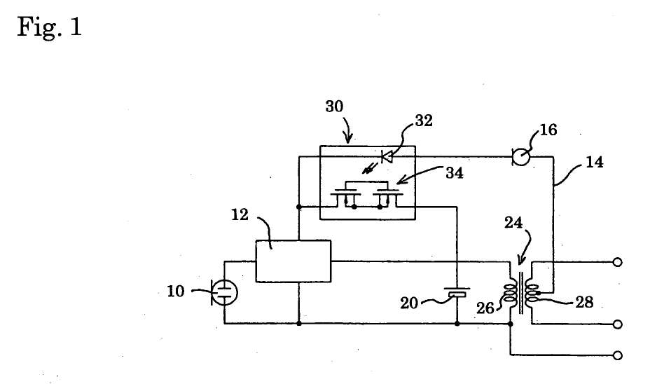

The invention will be described in detail with reference an embodiment shown in FIG. 1, in which parts identical to those of the related art have identical reference numbers.

Referring to FIG. 1, a capacitor microphone unit 10 has one terminal grounded and the other terminal connected to a microphone circuit 12. The microphone circuit 12 includes not only an FET which transduces impedance of the microphone unit 10 to low impedance but also an amplifier and so on. The microphone circuit 12 has its grounding terminal earthed, and receives phantom power via its power supply terminal from a phantom power supply circuit 14. Further, the microphone circuit 10 receives power from a built-in battery 20. A constant current circuit 16 constituted by a constant current diode or the like is connected to the phantom power supply circuit 14, and supplies a constant current to the microphone circuit 12 while the phantom power supply 14 is in use. This controls consumption currents.

A light emitting diode 32 of a photo-MOS relay 30 is connected in series to the phantom power supply circuit 14, and emits lights when the phantom power supply circuit 16 supplies phantom power. A power supply circuit supplying power to the microphone circuit 12 from the built-in battery 20 is connected to two MOSFETs 34 constituting the photo-MOS relay 30. Gates of the two MOSFETs 34 are connected, so that a source and a drain are connected in series. When the bases of the two MOSFETs 34 are illuminated, the two MOSFETs 34 are turned off, i.e. are insulated, the power supply circuit between the builtin battery 20 and the microphone circuit 12 is disconnected. Therefore, when the phantom power is supplied from the phantom power supply 14, the microphone circuit 12 is operated only by the phantom power. If the phantom power is interrupted due to blackout or the like, and the light emitting diode 32 will be turned off, but the two MOSFETs 34 will be turned on, so that currents will flow in both directions. Thereafter, the built-in battery 20 will supply power to the microphone circuit 12. In this state, resistance is low between terminals of the two MOSFETs 34. Therefore, a voltage applied across the terminals of the MOSFETs 34 is remarkably low compared to a voltage of the schottky diode. The photo—MOS relays 30 are preferably relays TLP4176G manufactured by Kabushiki Kaisha Toshiba.

The photo-MOS relay 30 is connected as described above, so that the light emitting diode 32 emits two beams to illuminate the gates of the two MOSFETs 34 while power is supplied to the microphone circuit 12 from the phantom power supply 14. Therefore, the two MOSFETs 34 will be turned off, thereby interrupting the power supply circuit for the built-in battery 20 to the microphone circuit 12. This prevents the current of the phantom power from flowing to the built-in battery 20. If phantom power is interrupted from the phantom power supply circuit 14 due to blackout or the like, the power to the light emitting diode 32 of the photo-MOS relays 30 is stopped, which turns off the light emitting diode 32. Further, light fluxes to the two MOSFETs 34 of the photo-MOS relay 30 are interrupted. The two MOSFETs 34 are activated, and the built-in battery 20 supplies power to the microphone circuit 12, so that the microphone circuit 12 keeps on operating. As described so far, even when the phantom power supply is used as the main power supply but undergoes the blackout, the built-in battery 20 will be automatically activated, which enables the operation of the microphone to be continued without interruption. The light emitting diode 32 is connected to the phantom power supply 14, and serves a sensor detecting the present or absence of the power from the phantom power supply 14. The MOSFETs 34 are connected to the built-in battery 20, and disconnects the built-in battery 20 during the operation of the phantom power supply.

A minus terminal of the built-in battery 20 is grounded. The output terminal of the microphone circuit 12 is connected to one of terminals of the primary coil 26 of the transformer 24. The other terminal of the transformer 24 is connected to a grounding wire. The microphone body includes a standardized 3-pin connector, to which a cable connector is connected. The phantom power is supplied to the microphone from an external source. An electro-acoustically converted microphone output is sent to an external circuit. The foregoing grounding wire is connected to a grounding wire of the cable via a grounding terminal, and to a grounding wire of the external circuit. In FIG. 1, numerals 1, 2 and 3 denote terminal numbers of the connector. Specifically, No. 1 terminal is a grounding terminal; and No. 2 and No. 3 terminals are a hot-side terminal and a cold-side terminal, respectively, and produce voice signals. No. 2 terminal is connected to one of terminals of a secondary coil 28 of the transformer 24. No. 3 terminal is connected to the other terminal of the secondary coil 28. Phantom power is supplied to the microphone circuit 12 via the foregoing cable and 3-pin connector from the external source. In the microphone, a center tap is connected to the phantom power supply circuit 14, so that the phantom power is supplied to the microphone circuit 12.

When the microphone circuit 12 is operating on the built-in battery 20, the resistance between the photo-MOS relay 30, i.e., terminals between the two MOSFET 34, is 15 Ω in the case of TLP4176G manufactured by Kabushiki Kaisha Toshiba. If the built-in battery 20 supplies a current of 1 mA, voltage drop between the terminals of the two MOSFET 34 is 0.015V. This voltage drop is very small compared to a voltage drop of the foregoing diode. Therefore, the voltage of the built-in battery 20 is continuously applied to the microphone circuit 12. This is effective in keeping the output level of the microphone constant.

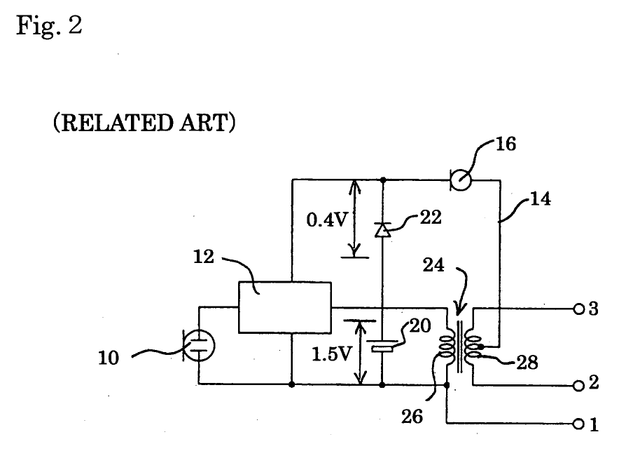

In the related art shown in FIG. 2, the diode is connected in series with the built-in battery 20 in order to prevent a current from being applied to the built-in battery 20 from the phantom power supply. A reverse current is supplied to the diode from the phantom power supply in order to prevent a current from the phantom power supply. For instance, in the case of a diode ISS198 manufactured by Hitachi, Ltd., when a reverse voltage of 6V is applied, an approximately 70 μA current flows to the built-in battery 20, which adversely affects the built-in battery 20. On the contrary, in the embodiment of the present invention, when the photo-MOS relay is turned off, the resistance is 1×10¹⁴ Ω, and substantially no reverse current flows to the built-in battery 20.

What is claimed is:

1. A capacitor microphone in which a microphone circuit is selectively operated by a phantom power supply receiving power from an external source and a built-in power supply, the capacitor microphone comprising:
a phantom power supply circuit provided between the phantom power supply and the microphone circuit;
a built-in power supply circuit provided between the built-in power supply and the microphone circuit;
a detector provided in the phantom power supply circuit, and detecting the presence or absence of power supplied from the phantom power supply; and
a switch provided in the built—in power supply circuit and interrupting the built-in power supply circuit when the detector detects the presence of power supplied from the phantom power supply.

2. The capacitor microphone of claim 1, wherein the detector is a light emitting diode provided in photo-MOS relays; and the switch is a MOSFET provided in the photo-MOS relays and opens and closes the built-in power supply circuit in response to blinking of the light-emitting diode.

3. The capacitor microphone of claim 2, wherein the light-emitting diode emits a light in response to power supply from the phantom power supply circuit, and the MOSFET interrupts the built-in power supply circuit in response to the light emitted by the light-emitting diode.
